(19) United States
(12) Patent Application Publication
(10) Pub. No.: US 2004/0059949 A1
(43) Pub. Date: Mar. 25, 2004

(54) Device ID dependent print jobs

(76) Inventors: Travis J. Parry, Boise, ID (US); Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/251,275

(22) Filed: Sep. 20, 2002

(51) Int. Cl. H04L 9/00

(52) U.S. Cl. 713/202

(57) ABSTRACT

This invention relates to the insertion of identifiers (IDs) of the printing device(s) that are allowed to process the print job. This ID could be the formatter ID of the printer or other such similar unique identifier. The ID could be listed within the header of the print job. Also, the ID could be encrypted or protected in some similar such manner.

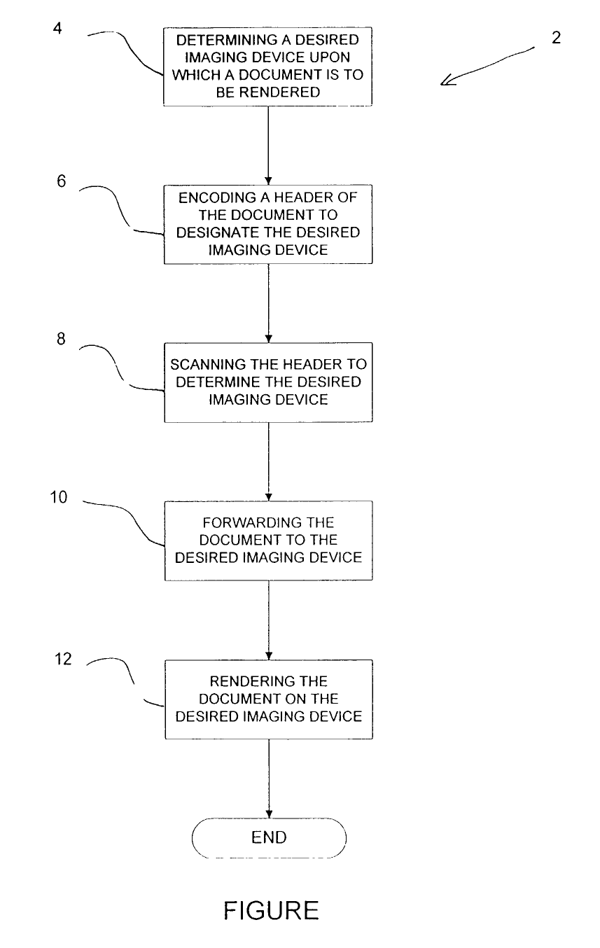

### BACKGROUND OF THE INVENTION

1. Field of the Invention

This invention relates to the insertion of identifiers (IDs) of the printing device(s) that are allowed to process the print job. This ID could be the formatter ID of the printer or other such similar unique identifier. The ID could be listed within the header of the print job. Also, the ID could be encrypted or protected in some similar such manner.

2. Description of the Related Art

Prior to the present invention, as set forth in general terms above and more specifically below, it is known, in the printing art, to employ a printing device that authenticates the user. Exemplary of such prior art is U.S. Pat. No. 5,633,932 ('932) to D. L. Davis et al., entitled “Apparatus and Method for Preventing Disclosure Through User-Authentication at a Printing Node.” The printing device of the '932 reference checks to make sure that the user can send the print job to the desired recipient, such a certain printer. In this manner, the printing device of the '932 reference merely authenticates the user and not the device upon which the print job is to be printed. Consequently, a more advantageous system, then, would be provided if the desired printing device, upon which the print job is to be printed, could be authenticated prior to the sending of the print job to the desired printing device.

It is also known, in the communications art, to employ a device that manages the transfer of electronic mail (e-mail) attachments to printing devices. Exemplary of such prior art is U.S. Pat. No. 6,360,252 ('252) to S. M. Rudy et al., entitled “Managing the Transfer of E-mail Attachments to Rendering Devices Other Than an Original E-mail Recipient.” The apparatus of the '252 reference discloses a server machine which transfers a version of the e-mail for presentation by a client machine. The version includes a user-understandable descriptor of an attachment to the e-mail, but does not include the attachment. The server receives a request from the client to transfer the attachment for rendering. In response, the server obtains an output version of the attachment and transfers the output version to a rendering device, thereby causing the rendering device to produce a rendered version of the attachment. In short, the '252 reference teaches the use of providing a destination for the print job, but not the ID of a particular printing device. Therefore, a further advantageous system, then, would be provided if the system would provide an ID that describes the particular printing device to be used.

It is apparent from the above that there exists a need in the art for a printing system which provides an ID descriptor that describes the desired printing device to be used and which authenticates the desired printing device, but which at the same time is capable of employing an encrypted or other similarly protected ID. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for employing device identification dependent rendering jobs, wherein the method is comprised of the steps of: determining a desired imaging device upon which a document is to be rendered; encoding a header of the document to designate the desired imaging device; scanning the header to determine the desired imaging device; forwarding a document to the desired imaging device; and rendering the document on the desired imaging device.

In certain preferred embodiments, the imaging device can be, but is not limited to, a printer, a printing device, a multi functional product (MFP), photocopier, facsimile machine or the like. Also, the header can be encoded with an identifier (ID) such as a particular printer model number, the formatter ID of the desired imaging device, a firmware version, an Internet protocol (IP) domain address, a subnet mask or any combination of similar unique identifiers. Also, the ID can be encoded with an encryption code or other such similar protection devices. Finally, the header is scanned by a computing device in order to forward the document to the desired imaging device.

In another further preferred embodiment, the system allows the user to specify only those particular imaging devices that would be allowed to render the particular rendering job. In this manner, no other imaging device, except for the designated imaging device, would be allowed to except the rendering job.

The above and other features of the present invention, which will become more apparent as the description proceeds, are best understood by considering the following detailed description in conjunction with the accompanying drawing FIGURE and in which:

### BRIEF DESCRIPTION OF THE DRAWING

The FIGURE is a flowchart of a method for employing device identification dependent rendering jobs, according to one embodiment of the present invention.

### DETAILED DESCRIPTION OF THE INVENTION

With reference to the FIGURE, there is illustrated one preferred embodiment for use of the concepts of this invention. The FIGURE illustrates method 2 for employing device identification dependent rendering jobs. Method 2 includes, in part, the steps of: determining a desired imaging device upon which a document is to be rendered (step 4); encoding a header of the document to designate the desired imaging device (step 6); scanning the header to determine the desired imaging device (step 8); forwarding a document to the desired imaging device (step 10); and rendering the document on the desired imaging device (step 12).

It is to be understood that the flowchart of the FIGURE shows the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute instructions contained therein. A “computer-readable medium” can be any medium that contains, stores, or maintains programming for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

With respect to step 4, the desired imaging device can be, but is not limited to, a printer, a printing device, a multi functional product (MFP), a photocopier, a facsimile machine or the like. It is to be understood that the user will select a desired imaging device such that only that particular imaging device will be allowed to render the print job.

With respect to step 6, a document to be rendered by the desired imaging device is conventionally prepared on a document processing device, such as a word processing device or other such suitable computing device. A document header is conventionally inserted into the document. A document header, typically, refers to a text area located near the top of the print job document that may contain, among other things, data related to message type and priority status. Also, the header can be encoded with an identifier (ID) such as a particular printer model number, formatter ID of the desired imaging device, a firmware version, an Internet protocol (IP) domain address, a subnet mask, vendor ID (specific brand), reseller ID, imaging device class (print vs. fax; color vs. monochrome) or any combination of similar unique identifiers. Also, the ID can be encoded with an encryption code or other such similar protection devices.

It is to be understood that the nature of the ID is that it will allow only those imaging devices set forth in the header to render the print job. In this manner, the user encrypts the header with the ID of the desired imaging device.

With respect to step 8, the header is conventionally scanned by a computing device in order to forward the document to the desired imaging device.

With respect to step 10, after the header has been conventionally scanned, the document is conventionally forwarded to the desired imaging device. It is to be understood that during this step, the document processing device can, for example, contact or ping all the imaging devices which the document processing device is capable of sending documents to be rendered. The document processing device conventionally interacts with all of the imaging devices to determine which imaging device is associated with the unique ID located in the header.

Finally, with respect to step 12, the document is conventionally rendered by the desired imaging device.

The efficacy of the present invention will now be discussed. The present invention is advantageous because it allows the user to specify only certain particular imaging devices that can render this particular print job. For example, a confidential print job is created by the user and stored in a print ready format on the user's printer with the printer identifier (ID) included in the header of the print job. If, at a later time, an unauthorized user attempts to hack or break into the user's printer that was rendering the confidential print job, the unauthorized user would be unable to print the confidential print job on another imaging device. This is because the printer ID located in the header of the confidential print job would contain the ID of the user's printer. Therefore, no other imaging device would accept the confidential print job.

Although the flowchart of the FIGURE shows a specific order of execution, the order of execution may differ from that which is depicted. For example, the order of execution of two or more blocks may be scrambled relative to the order shown. Also, two or more blocks shown in succession in the FIGURE may be executed concurrently or with partial concurrence. All such variations are within the scope of the present invention.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for employing device identification dependent rendering jobs, comprising the steps of:
determining a desired imaging device upon which a document is to be rendered;
encoding a header of the document to designate the desired imaging device;
scanning the header to determine the desired imaging device;
forwarding a document to the desired imaging device; and
rendering the document on the desired imaging device.

2. The method, as in claim 1, wherein said desired imaging device is further comprised of:
a printing device.

3. The method, as in claim 1, wherein said encoding step is further comprised of the step of:
encoding a unique identifier of said desired imaging device in said header.

4. The method, as in claim 3, wherein said unique identifier is further comprised of:
a desired imaging device model number.

5. The method, as in claim 3, wherein said unique identifier is further comprised of:
an Internet protocol address.

6. The method, as in claim 3, wherein said unique identifier is further comprised of:
a subnet mask.

7. The method, as in claim 1, wherein said scanning step is further comprised of the step of:
scanning said header by a computing device.

8. The method, as in claim 1, wherein said forwarding step is further comprised of the step of:
interacting with an imaging device to determine if said imaging device is said desired imaging device.

9. A computer-readable medium having instructions for:
determining a desired imaging device upon which a document is to be rendered;
encoding a header of the document to designate the desired imaging device;
scanning the header to determine the desired imaging device;
forwarding a document to the desired imaging device; and
rendering the document on the desired imaging device.

10. The medium, as in claim 9, wherein said desired imaging device is further comprised of:
a printing device.

11. The medium, as in claim 9, wherein said encoding step is further comprised of the step of:
encoding a unique identifier of said desired imaging device in said header.

12. The medium, as in claim 11, wherein said unique identifier is further comprised of:
a desired imaging device model number.

13. The medium, as in claim 11, wherein said unique identifier is further comprised of:
an Internet protocol address.

14. The medium, as in claim 11, wherein said unique identifier is further comprised of:
a subnet mask.

15. The medium, as in claim 9, wherein said scanning step is further comprised of the step of:
scanning said header by a computing device.

16. The medium, as in claim 9, wherein said forwarding step is further comprised of the step of:
interacting with an imaging device to determine if said imaging device is said desired imaging device.

17. A document rendering method comprising the steps of:
determining a desired imaging device upon which a document is to be rendered;
encoding a header of the document to designate the desired imaging device;
scanning the header to determine the desired imaging device;
forwarding a document to the desired imaging device; and
rendering the document on the desired imaging device.

18. The method, as in claim 17, wherein said desired imaging device is further comprised of:
a printing device.

19. The method, as in claim 17, wherein said encoding step is further comprised of the step of:
encoding a unique identifier of said desired imaging device in said header.

20. The method, as in claim 19, wherein said unique identifier is further comprised of:
a desired imaging device model number.

21. The method, as in claim 19, wherein said unique identifier is further comprised of:
an Internet protocol address.

22. The method, as in claim 19, wherein said unique identifier is further comprised of:
a subnet mask.

23. The method, as in claim 17, wherein said scanning step is further comprised of the step of:
scanning said header by a computing device.

24. The method, as in claim 17, wherein said forwarding step is further comprised of the step of:
interacting with an imaging device to determine if said imaging device is said desired imaging device.

25. A computer-readable memory device encoded with a data structure for employing device identification dependent rendering jobs, comprising the steps of:
determining a desired imaging device upon which a document is to be rendered;
encoding a header of the document to designate the desired imaging device;
scanning the header to determine the desired imaging device;
forwarding a document to the desired imaging device; and
rendering the document on the desired imaging device.

26. The device, as in claim 25, wherein said desired imaging device is further comprised of:
a printing device.

27. The device, as in claim 25, wherein said encoding step is further comprised of the step of:
encoding a unique identifier of said desired imaging device in said header.

28. The device, as in claim 27, wherein said unique identifier is further comprised of:
a desired imaging device model number.

29. The device, as in claim 27, wherein said unique identifier is further comprised of:
an Internet protocol address.

30. The device, as in claim 27, wherein said unique identifier is further comprised of:
a subnet mask.

31. The device, as in claim 25, wherein said scanning step is further comprised of the step of:
scanning said header by a computing device.

32. The device, as in claim 25, wherein said forwarding step is further comprised of the step of:
interacting with an imaging device to determine if said imaging device is said desired imaging device.
